(19) United States
(12) Patent Application Publication
(10) Pub. No.: US 2026/0192443 A1
(43) Pub. Date: Jul. 9, 2026

(54) Extramuscular-Assisted Robotic Glove

(71) Applicant: The Regents of the University of Colorado, a body corporate, Denver, CO (US)

(72) Inventors: Spencer Dansereau, Boulder, CO (US); Danielle Carroll, Boulder, CO (US)

(21) Appl. No.: 18/868,409

(22) PCT Filed: May 24, 2023
(86) PCT No.: PCT/US2023/023308

§ 371 Date: Nov. 22, 2024

Related U.S. Application Data
(60) Provisional application No. 63/345,115, filed on May 24, 2022.

(51) Int. Cl. B25J 9/16; B25J 9/00; B25J 9/10; B25J 13/08

(52) U.S. Cl. CPC B25J 9/1612; B25J 9/0006; B25J 9/104; B25J 13/087

(57) ABSTRACT

A system, method of operation, and devices are disclosed herein for a robotic glove to augment a user's manual grip and mitigate risk of injury. In an implementation, a robotic glove includes one or more finger portions, a motor assembly, and a controller. The motor assembly is connected by a line to each of the one or more finger portions and maintains tension in the lines as the one or more finger portions move. The controller is configured to detect a gripping motion by the user and provide a grip assist. To provide the grip assist, the controller is configured to hold the motor assembly in the retracted position and to cause the motor assembly to take up slack in the lines.

### RELATED APPLICATIONS

This application is related to and claims the benefit of priority to International Patent Application No. PCT/US2023/023308, entitled “EXTRAMUSCULAR-ASSISTED ROBOTIC GLOVE,” filed on May 24, 2023; which claims priority to U.S. Provisional Patent Application No. 63/345,115, entitled EXTRAMUSCULAR-ASSISTED ROBOTIC GLOVE, filed on May 24, 2022, the contents of each of which are hereby incorporated by reference in their entirety.

### TECHNICAL FIELD

Various implementations of the technology relate to a system for power-augmented manual gripping and fingertip protection to reduce injury and fatigue.

### BACKGROUND

Astronauts are prone to repetitive movement injuries to their hands when working in the spaceflight environment. During spacewalks, or extravehicular activity (EVA), astronauts wear pressurized gloves to perform various manual tasks such as repairs and maintenance. These spacesuit gloves, which are typically worn for several hours at a time during an EVA, are by their nature bulky and can limit the natural movement of the astronaut's fingers and hands. Performing manual-intensive work such as gripping and manipulating hand tools while wearing the EVA gloves causes the muscles of the fingers and hands to work harder over long periods of time and subjects the fingertips to compressive forces, which can damage the vasculature of the fingertips and fingernails. Repetitive motion injuries arise when astronauts are conducting EVA operations, as well as when crews are training for spacewalk activities on the ground—nine to ten hours or more of training for every planned hour of in-mission EVA. Injury patterns from EVA include bruising at the fingernail bed leading to separation of the fingernail, fingernail delamination (or onycholysis), and muscle fatigue of hands and forearms. Besides the more immediate pain or discomfort, these injuries can also lead to chronic injuries and infections from repeated fingernail delamination events. In addition, early muscle fatigue is known to limit the length of time an astronaut can work during an EVA.

Not unlike the challenges of wearing spacesuit gloves while working in the spaceflight environment are some of the effects of nervous system or neuromuscular disorders seen terrestrially, such as amyotrophic lateral sclerosis or Parkinson's disease. Individuals with these clinical conditions may lack sufficient hand strength, finger strength, or muscle control to form a secure grip. So, too, do persons who have lost the use of one or more fingers face challenges in performing a variety of manual tasks. These individuals may avail themselves of adaptive technologies to assist with performing everyday tasks, but adaptive technologies are often designed for a specific task rather than directed to augmenting a particular type of mobility.

Glove designs to enhance mobility typically rely on a complex system of mechanical actuators which add weight, bulk, and complexity to EVA gloves. Moreover, mechanical devices are typically designed and built in a limited number of sizes. To redesign and build a mechanical glove customized for a particular user is a time-consuming and expensive process, the end product of which may have limited use.

### TECHNICAL OVERVIEW

A system, method of operation, and devices are disclosed herein for a robotic glove to augment a user's manual grip and mitigate risk of injury. In an implementation, a robotic glove includes one or more finger portions, a motor assembly, and a controller. The motor assembly is connected by a line to each of the one or more finger portions and maintains tension in the lines as the one or more finger portions move. The controller is configured to detect a gripping motion by the user and provide a grip assist. To provide the grip assist, the controller is configured to hold the motor assembly in the retracted position and to cause the motor assembly to take up slack in the lines.

In an implementation, the controller is further configured to power a solenoid to hold the motor assembly at the retracted position. To cause the motor assembly to take up slack in the lines, the controller is further configured to power a motor to retract the lines to the one or more finger portions.

This Technical Overview is provided to introduce a selection of concepts in a simplified form that are further described below in the Detailed Description. This Technical Overview is not intended to identify key features or essential features of the claimed subject matter, nor is it intended to be used as an aid in determining the scope of the claimed subject matter.

While multiple implementations are disclosed, still other implementations of the technology will become apparent to those skilled in the art from the following detailed description. As will be realized, aspects of the technology are capable of modification, all without departing from the scope of the technology. Accordingly, the drawings and detailed description are to be regarded as illustrative in nature and not restrictive.

### BRIEF DESCRIPTION OF THE DRAWINGS

FIG. 1 illustrates an operational architecture of a robotic glove system for augmenting manual grip in an implementation.

FIG. 2 illustrates a method operating a robotic glove system in an implementation.

FIGS. 3A and 3B illustrate a robotic glove system in an implementation.

FIG. 4 illustrates a robotic glove system in an implementation.

FIGS. 5A and 5B illustrate a fingertip cap of a robotic glove system in an implementation.

FIGS. 6A and 6B illustrate a motor retraction system of a robotic glove system in an implementation.

FIGS. 7A and 7B illustrate fingertip caps of a robotic glove in an implementation.

FIG. 8 illustrates a robotic glove system in an implementation.

The drawings have not necessarily been drawn to scale. Similarly, some components and/or operations may be separated into different blocks or combined into a single block for the purposes of discussion of some of the implementations of the present technology. Moreover, while the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Devices, methods, and software are disclosed herein for a robotic glove system to augment a user's manual grip. In the spaceflight environment, astronauts are susceptible to injury to their hands and fingers as well as to muscular fatigue when performing extravehicular activity (EVA) during crewed missions. In addition to exerting the force necessary to complete a task, the muscles of the astronaut's hands must also work against the stiffness and bulkiness of the pressurized spacesuit gloves. These gloves may also restrict the natural movement of the astronaut's hands and fingers. Given the many hours of training on the ground along with the time to execute manual tasks on orbit, these effects add up to create a strenuous environment which leads to injuries to astronauts'hands and fingers as well as early muscle fatigue. Besides the immediate pain or discomfort, recurring injuries to the hands and fingers can also lead to chronic injury and even infections. For example, sustained EVA work can cause bruising of the fingertips and fingernails which can lead to losing a fingernail, creating an opportunity for infection to set in. Early onset of muscle fatigue limits the amount of time an astronaut can work during a spacewalk. Launch costs drive a very high level of efficiency in spaceflight operations, and every task must be performed as quickly and easily as possible. Therefore, reducing the physical effort required for an astronaut to complete EVA tasks will enable crewmembers to complete these tasks more efficiently, translating to more efficient utilization of time and resources in the constrained spaceflight environment.

In the terrestrial setting, certain physically demanding jobs or repetitive activities can lead to hand injury, for example, medical personnel carrying injured patients on litters over long distances, such as in combat zones, are at risk of injury to the hands and/or arms from the sustained exertion. In addition to occupational health risks, disorders of the neuromuscular or nervous system can render it difficult to use one's hands to grip objects. For example, for persons who have substantially lost the use of one or more fingers due to injury or disease, activities involving fine motor control, such as holding a pen or an eating utensil, can be challenging.

To address these and other similar problems, a robotic glove is disclosed herein to augment a user's hand grip. In an implementation, the robotic glove operates by detecting when the user is gripping an object, then actuating a gripping mechanism to augment the user's gripping force. The robotic gloves detect when a user is gripping his or her hand by sensing electromyographic (EMG) signals from the user's finger, hand, forearm, and/or upper arm muscles. The robotic glove provides a mechanical grip, which reduces the grip force required by the user's hand and lessens the pressure on the user's fingertips. Thus, the user can securely grip an object with less force than would otherwise be required. Reducing the required force will limit the incidence of injury to the fingers and hands and lessen muscle fatigue, allowing the user to work for longer periods of time, and with less exertion and discomfort. Because the system automatically detects when the user is exerting a gripping motion, a user can implement the robotic glove in a variety of situations.

In an implementation, the robotic glove comprises a motor assembly positioned on the ventral forearm. From the motor assembly, lines extend across the palm of the hand and attach to fingertip caps of the robotic glove, effecting a system of artificial tendons to mimic actual tendons that are part of the hand anatomy. Each line tethers a fingertip cap of the robotic glove to the motor assembly and, in operation, can draw and hold the glove finger in a gripping configuration.

To avoid fingertip injury from the gripping force, the robotic glove comprises one or more offloading fingertip caps, each of which distributes the gripping force over a larger area of the end of the user's finger to avoid concentrated pressure at or on the user's fingertip. In an implementation, the fingertip caps are hard shells which are bonded to the fingertips of a flexible glove, such as with an epoxy or flexible adhesive. Each fingertip cap protects the user's fingertip from axial forces due to glove end buckling or transverse forces. In an implementation, the glove may be configured to position a gap between the fingertip caps and the user's fingertips to further protect the user's fingertips from possible injury due to buckling. In other implementations, an offset fingertip cap is secured to the flexible glove by a flexible band (e.g., elastomeric or silicon band) with struts holding the fingertip cap in a position offset from the fingertip of the glove.

Each of one or more lines extending from the motor assembly to a glove fingertip is secured to the fingertip cap to hold the glove finger in position while the robotic glove is in the gripping configuration. The line may be secured to the respective fingertip caps at attachment points at the top of the cap (i.e., at or near the tip of the user's fingertip). In various implementations, the line is secured to the fingertip cap in multiple locations for redundancy, such as at one or more locations along the top of the fingertip cap or at locations along a side or bottom edge of the fingertip cap. The fingertip caps may have multiple ventilation holes or perforations to allow air to circulate for comfort and to mitigate perspiration.

Lines from each fingertip cap are positioned along the glove finger and across the palm and attach to a motor on the motor assembly. To avoid entanglement or displacement, the lines are maintained in position on the palm side of the glove by line retention devices at various locations on the fingers and on the palmar surface. In some implementations, the lines are retained by rings encircling the glove fingers beneath which the lines pass. For example, one or more retention rings may be positioned around the proximal and/or intermediate phalanges of the user's fingers. In various implementations, the line retention devices may be tubes or sleeves on the glove through which the lines pass. In still other implementations, multiple lines run between each fingertip cap and the motor assembly for greater gripping force and/or for redundancy.

As the user wears the robotic glove, the motor assembly moves up and down the user's ventral forearm to maintain tension in the lines. In an implementation, the motor assembly may be mounted on a rail system comprising low-friction bearings to slide back and forth on the forearm. The motor assembly includes a light spring which pulls the motor assembly toward the distal or retracted position (i.e., the position of the motor assembly is farthest from the hand and closest to the elbow). When the fingers are fully extended, the motor assembly is in a neutral or unretracted configuration (i.e., the position of the motor assembly is closest to the hand) with the spring extended. As the fingers curl or contract, the spring pulls the motor assembly toward the retracted position to maintain the tension in the lines. The spring is sized to exert enough pull to maintain the tension in the lines, but not so much as to cause the user's fingers to have to work against the pull of the spring.

When the user contracts his or her fingers to grip an object, the EMG sensors on the robotic glove detect muscle activity in the user's arm corresponding to the gripping motion and transmit electrical signals arising from the muscle activity to a controller. When the controller discerns the gripping motion from the electrical signals, it locks the motor assembly in place at retracted position at the distal end of the rail system (i.e., farthest from the hand) and activates a motor to spool the lines to take up any additional slack. In an implementation, the controller powers a solenoid to lock the motor assembly at the distal or retracted position. The controller also powers the motor to spool the lines to take up the additional slack while the glove is in the contracted or gripping configuration. With the glove fingers in the gripping configuration and the lines taut, the controller cuts off power to the solenoid and the motor. The motor assembly is locked in its position on the rail system. Because the solenoid is used to actuate a lock on the motor assembly and does not draw power as the lock is maintained, the system is well-suited for use with battery-powered systems or in power-limited operating environments.

When the robotic grip is no longer needed (e.g., the user wants to release the object), the user can trigger the glove to release the grip by activating by a button connected to the controller, by issuing a voice command to a voice control system integrated into the controller, or by the controller detecting muscle activity indicative of the user releasing his or her grip from the EMG sensors, such as the user straightening one or more of his or her fingers. As the user relaxes or extends his or her fingers, the motor assembly again moves back and forth on the rail system.

In some scenarios, the motor assembly of the robotic glove may be positioned on the dorsal forearm. Lines extending from the motor assembly are guided by a line-retention system or a system of pulleys to the ventral side of the forearm, then directed up to the fingertip caps. In an implementation, a system of pulleys includes one or more pulleys to guide the lines, together or individually, toward the ventral side of the forearm, where another one or more pulleys guide the lines, together or individually, toward the fingertip caps. In some implementations, a system of pulleys and line retention devices guide the lines from the dorsal forearm to the ventral forearm and then to the fingertip caps. For example, for each line, a first pulley guides or turns the lines toward the ventral forearm where line retention devices are used to individually guide the lines toward the fingertip caps. In another implementation, each line is guided by a dedicated pulley system or pulley and retention system.

The robotic glove may also include fail-safe mechanisms. For example, the default state of the solenoid is to be unpowered, and the hold of the solenoid on the motor assembly will only be activated when power is available. In addition, in the contracted or gripped configuration, the hold of the solenoid on the motor assembly may be overcome with sufficient force from the user's gloved hand or other hand.

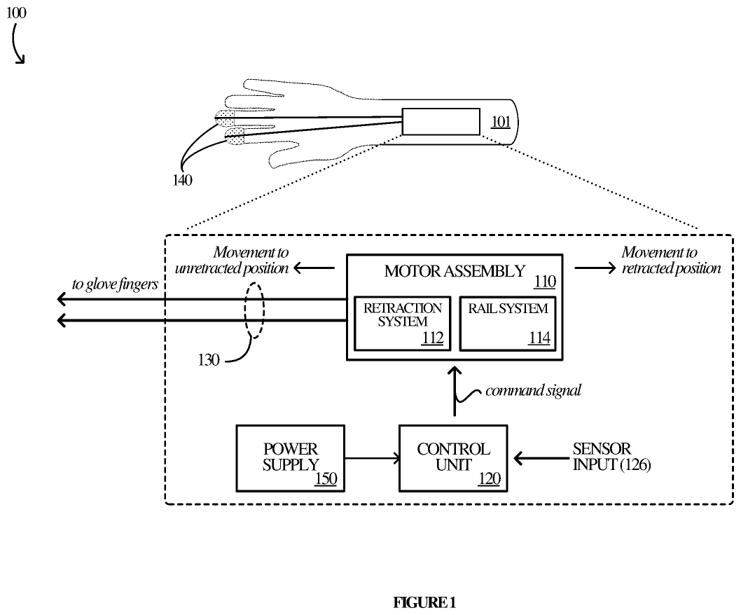

Turning now to the Figure, FIG. 1 illustrates operational architecture 100 of robotic glove system 101 in an implementation. Operational architecture 100 includes motor assembly 110, control unit 120, and power supply 150. Control unit 120 includes one or more onboard processors (not shown) and program instructions stored on non-transitory computer-readable storage media. The program instructions direct control unit 120 to detect a gripping motion by the user by receiving and detecting electrical signals associated with neuromuscular activity and to provide a grip assist by holding the motor assembly in a retracted position and causing motor assembly 110 to take up slack in lines 130. Control unit 120 receives power from power supply 150. Control unit 120 is operatively connected to motor assembly 110 and controls power to motor assembly 110. Control unit 120 also receives sensor input 126 from one or more sensors (not shown). Sensor input 126 is representative of electrical signals received by sensors attached to the user's (i.e., the robotic glove wearer's) arm. Control unit 120 transmits a command or activation signal to motor assembly 110, such as a signal which causes motor assembly 110 to retract, lock, or release lines 130. In some implementations, control unit 120 transmits data, such as data relating to glove operation, to another system, such as a system for monitoring the integrity of the spacesuit to which robotic glove system 101 is attached.

In operational architecture 100, motor assembly 110 of operational architecture 100 includes retraction system 112 and rail system 114. Motor assembly 110 attaches by lines 130 to fingertip caps 140 of robotic glove system 101. Motor assembly 110 moves by means of rail system 114 linearly (i.e., back and forth) to maintain tension in lines 130 as the glove fingers move (i.e., as the user extends or contracts his or her fingers). In an implementation, rail system 114 of motor assembly 110 includes a track, a sled, and bearings which enable smooth movement of motor assembly 110 over a given length of track. Motor assembly 110 also includes retraction system 112 which coils lines 130 to reduce or eliminate slack when robotic glove system 101 is in a gripping configuration. Retraction system 112 may also include a spring system which pulls motor assembly 110 into a retracted position. In operation, the default status or position of motor assembly 110 may be a neutral position (i.e., able to move freely) or an unretracted position (i.e., positioned closest to the hand) allowing for the greatest flexibility in hand movement. The default position may also be the fail-safe position. For example, in the event of a system failure (e.g., power loss or signal failure), control unit 120 may programmed to return to motor assembly 110 to the default position allowing the user the most freedom of movement with respect to robotic glove system 101.

In an implementation, a user wears robotic glove system 101 under another glove, such as a pressurized EVA glove during a spacewalk. In other implementations, robotic glove system 101 may be worn over a glove liner or directly over the user's hand and forearm with the motor assembly attached to a sleeve around the forearm. In still other implementations, robotic glove system 101 may be integrated into a glove.

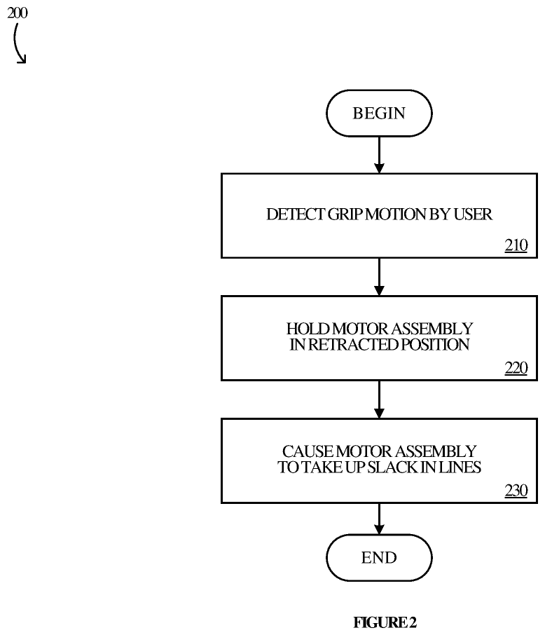

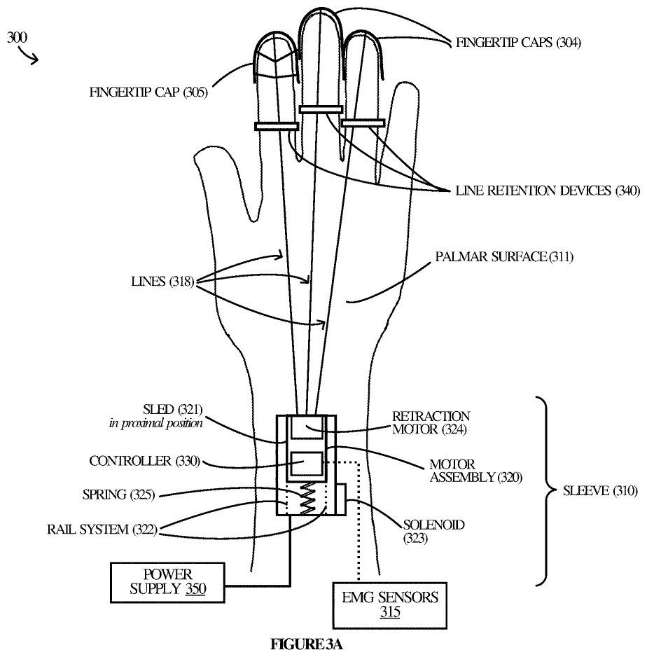

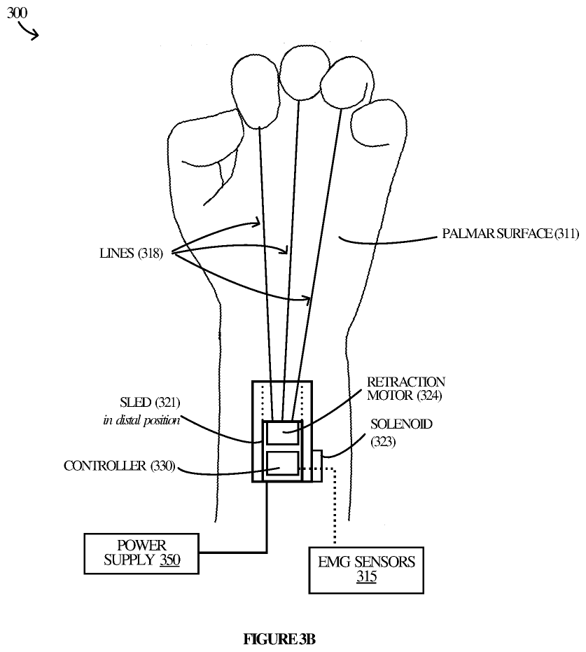

In operation, robotic glove system 101 employs process 200 illustrated in FIG. 2. Process 200 may be executed by a robotic glove system such as robotic glove system 101 of FIG. 1 or robotic glove 300 of FIGS. 3A and 3B. Program instructions in a controller of the robotic glove direct the robotic glove to operate according to process 200 described below, referring parenthetically to the steps in FIG. 2.

In operation, a user wears the robotic glove system under a glove such as an EVA glove. In an implementation, one or more EMG sensors attached to the user's arm transmit electrical signals from muscle activity in the user's forearm, hand, and/or fingers to a controller on a robotic glove. The EMG sensors are attached at various locations on the user's forearm, such as on the ventral and/or dorsal side.

The controller of the robotic glove receives the signals and detects the user performing a gripping motion with his or her gloved hand based on the electrical signals of the neuromuscular activity in the user's forearm (step 210). In an implementation, the electrical signals captured by the EMG sensors are electrical signals of neuromuscular activity in the user's arm. The EMG sensors are connected to the controller by electrical leads which transmit the neuromuscular signals detected in the user's arm to the controller. A processor onboard the controller receives the neuromuscular signals captured by the EMG sensors and analyzes the signals to identify different types of motor activity in the user's arm.

In response to detecting the gripping motion, the controller locks the motor assembly in place (step 220) and retracts the lines to take up slack (step 230). In an implementation, when the controller detects the gripping motion based on the neuromuscular signals, the controller signals to a solenoid to hold the motor assembly in a retracted position. The controller also signals a retraction motor of the retraction system to take up slack in the lines to the fingertip caps and hold the lines in possession. When the controller detects or receives an indication in the neuromuscular signals that the grip motion has stopped, the controller releases the hold of the lines and the retraction of the motor assembly so it can again move up and down the user's forearm. In an implementation, the controller controls the retraction motor and the solenoid by controlling power to the retraction motor and the solenoid.

Referring again to FIG. 1, operational architecture 100 illustrates a brief example of process 200 as employed by elements of robotic glove system 101 in an implementation. In an exemplary scenario, a user is performing a task while wearing robotic glove system 101. As the user curls his or her fingers into a gripping or holding configuration, control unit 120 receives sensor input 126 and detects an indication from sensor input 126 of a manual gripping motion by the user. In response to detecting the gripping motion based on sensor input 126, control unit 120 transmits a command to retract to motor assembly 110.

As the user performs the gripping motion, rail system 114 slides motor assembly 110 to a retracted position on the user's arm so that lines 130 are pulled or held taut. In various implementations, motor assembly 110 is pulled by a spring system (not shown) of retraction system 112, such as a torsion spring, into the retracted position and a solenoid of motor assembly 110 is activated by control unit 120 to hold motor assembly 110 in the retracted position. As motor assembly 110 slides to or is held in the retracted position, a motor of retraction system 112 onboard motor assembly 110 is activated by control unit 120 to reel in lines 130 to take up slack.

As the user maintains his or her hand in a gripping configuration, control unit 120 may continue to receive and monitor sensor input 126 with respect to the user's hand configuration. Upon detecting that the user has released his or her grip, control unit 120 sends a release command to motor assembly 110 to return to a neutral or default configuration so that lines 130 are loosened. For example, to return to the neutral or default configuration may include causing the solenoid of motor assembly 110 to release motor assembly 110 from the retracted position and causing retraction system 112 to unspool lines 130. In the neutral or default configuration, a spring system of retraction system 114 may exert a light force on motor assembly 110 to take up slack as the glove fingers move.

FIG. 3A illustrates robotic glove 300 in a neutral configuration in an implementation. Robotic glove 300 extends from the user's forearm to the user's fingertips. Motor assembly 320 is positioned on the ventral side of sleeve 310 of robotic glove 300. Motor assembly 320 includes sled 321 which slides on rail system 322 and spring 325 which pulls sled 321 toward the distal end of rail system 322 to maintain tension on lines 318 as the user is moving his or her fingers. When the user's hand forms a grip, spring 325 pulls sled 321 to the retracted position.

Controller 330 controls solenoid 323 and retraction motor 324 of motor assembly 320. Controller 330 is also connected to and receives signals from EMG sensors 315. EMG sensors 315 attach to one or more locations on the user's arm and transmit electrical signals arising from muscle activity in the user's arm to controller 330. Retraction motor 324, affixed to sled 321, connects to one or more lines 318 which are connected to one or more of fingertip caps 304 secured to the glove fingers. When activated by controller 330, retraction motor 324 spools or unspools lines 318 according to the configuration determined by controller 330. Power supply 350 powers various components of robotic glove 300 including controller 330, solenoid 323, and retraction motor 324. Although the implementation shown in FIG. 3 comprises a robotic glove for a user's left hand, an analogous configuration can be implemented for the user's right hand with no loss of generality.

In an implementation, lines 318 extend from retraction motor 324 to connect to fingertip caps 304 and 305 at one or more attachment points on the fingertip caps. For example, FIG. 3A demonstrates one of lines 318 secured to fingertip cap 305 of the index finger at multiple attachment points. Line retention devices 340 encircle the glove fingers at one or more locations on the glove finger to prevent lines 318 from becoming displaced or tangled. In other implementations, a finger frame comprising struts affixed to a silicon ring at the base of the distal phalanx allows for offloading of forces from the fingertip, redistributing the forces away from the sensitive, ischemia-prone soft tissue of the fingertip to a location on the fingers with more robust and redundant blood flow.

FIG. 3B illustrates robotic glove 300 in a gripping configuration. In this configuration, sled 321 is pulled to the retracted position by spring 325 and held in the retracted position by solenoid 323. The fingers of the glove are held in the gripping configuration by the retraction of lines 318 by retraction motor 324.

In various implementations, the robotic glove system is configured to hold one or more glove fingers (i.e., index, middle, ring, and pinky fingers) in a curled position. In an implementation, the robotic glove includes fingertip caps for at least the middle and ring fingers. In other implementations, the robotic glove includes fingertip caps for at least the index and middle fingers.

In an implementation, lines 318 are thin steel wires with high tensile strength, for example, a high E string on a guitar.

In an implementation, motor assembly 320 includes a retraction motor for each line such that the tension or pull of each line can be individually controlled by the controller.

In an implementation, the solenoid is a latching or bistable solenoid. The solenoid may also include a permanent magnet which holds or locks the motor assembly at the retracted position. The solenoid releases the motor assembly by an electromagnetic pulse which overcomes the permanent magnet. In an implementation, the solenoid uses pulses of opposing polarity for holding and releasing the motor assembly.

In an implementation, the robotic glove includes a set of individual glove fingers and a forearm sleeve such that the glove fingers are not attached to the sleeve.

In some implementations, a glove finger or fingertip cap of the robotic glove includes a pulse oximeter to detect blood oxygen level at the fingertip which can indicate when there is the potential for tissue damage to the fingertips. The pulse oximeter may transmit blood oxygen data to the controller which, upon detecting a drop in blood oxygen saturation, may respond by increasing the pull on the lines to alleviate the pressure on the user's fingertips.

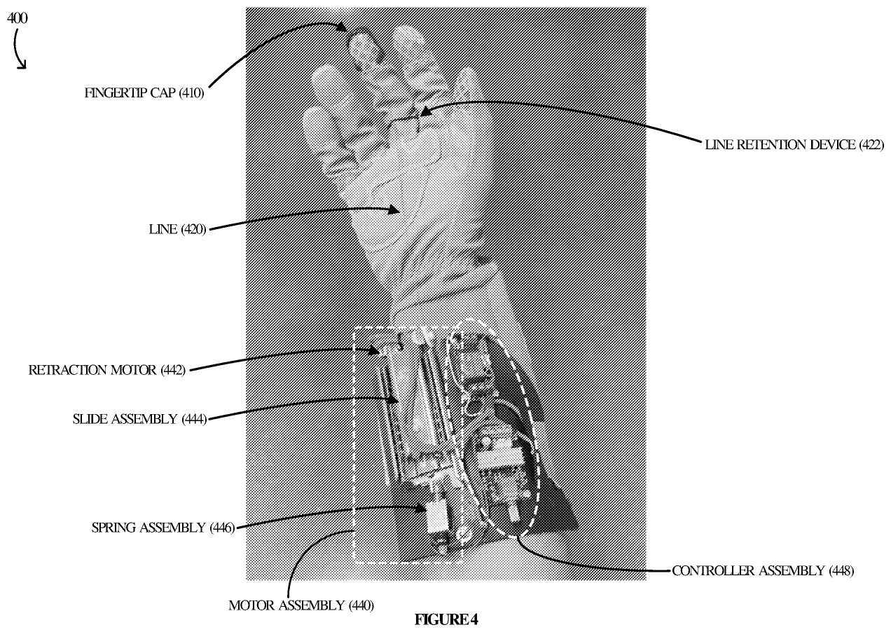

FIG. 4 illustrates robotic glove 400 in an implementation. Robotic glove 400 as shown is in a neutral (i.e., non-gripping) configuration. At the end of the middle finger of robotic glove 400 is fingertip cap 410. Fingertip cap 410 is bonded to robotic glove 400 with an adhesive suitable for the working environment, such as a vacuum environment or low- or high-temperature environment. Line 420 passes from fingertip cap 410 through line retention device 422, across the wearer's palm, to retraction motor 442 of motor assembly 440.

Motor assembly 440 includes retraction motor 442, slide assembly 444, and spring assembly 446. Parts of motor assembly 440 are powered by a power supply (not shown) which also powers controller assembly 448.

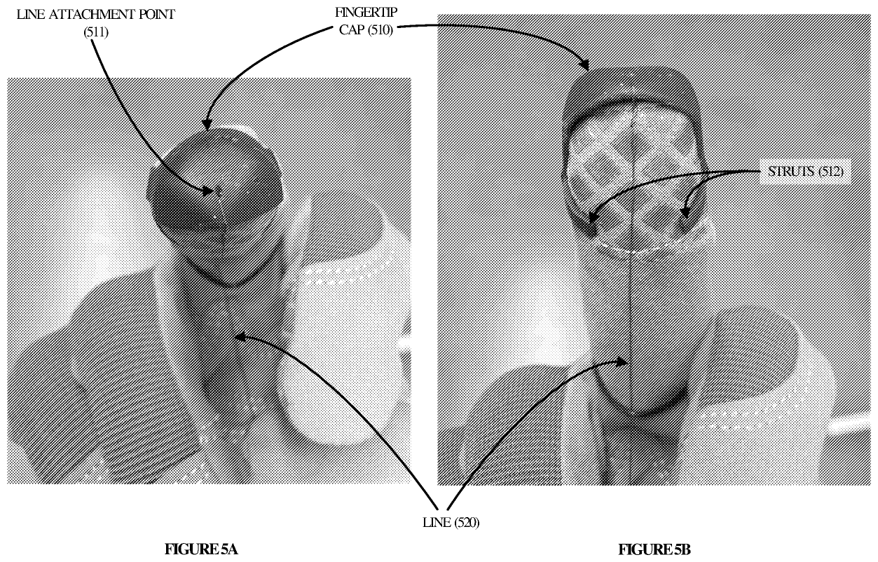

FIGS. 5A and 5B illustrate close-up views of fingertip cap 510 of which fingertip caps 140 of FIG. 1 are representative, in an implementation. Line 520 is secured to the top of fingertip cap 510 by threading line 520 through a hole at line attachment point 511. In an implementation, the hole is reinforced to resist wear. Fingertip cap 510 is bonded to robotic glove 500 with an adhesive or epoxy. Fingertip cap 510 further comprises struts 512 which provide additional circumferential support to hold fingertip cap 510 in position. In various implementations, line 520 is secured to fingertip cap 510 at multiple locations on fingertip cap 510 for redundancy. In other implementations, two or more lines are secured to fingertip cap 510 to motor assembly 540 for redundancy and greater gripping force.

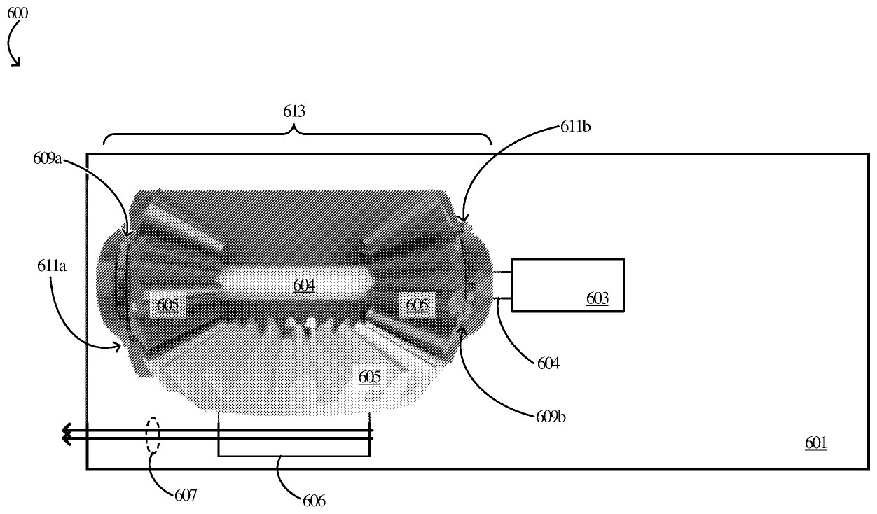

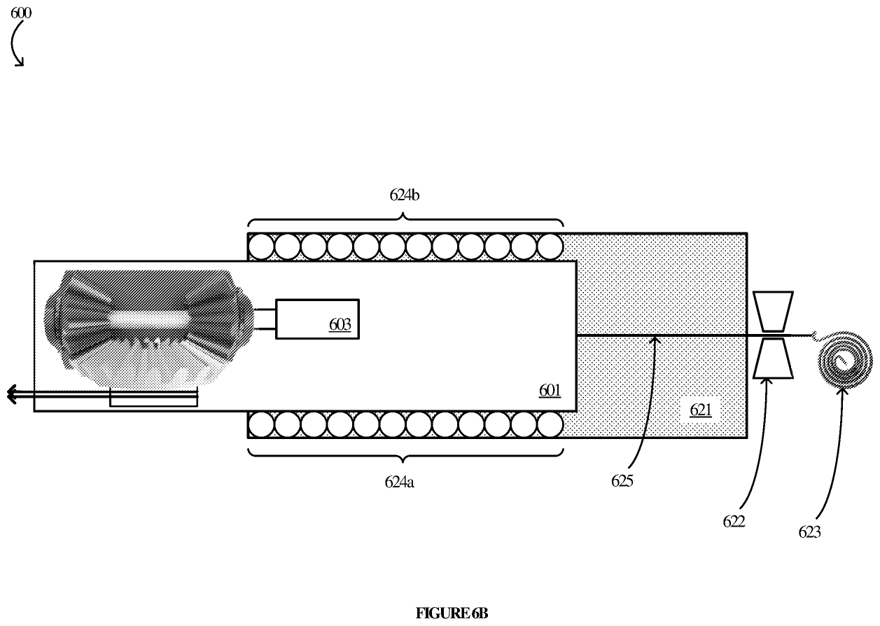

FIGS. 6A and 6B illustrate retraction system 600, of which retraction system 112 of FIG. 1 is representative, in an implementation. In FIG. 6A, a motor assembly (not shown) of a robotic glove system, such as robotic glove system 101 of FIG. 1, includes sled 601 to which retraction motor 603 and gear assembly 613 are mounted. Lines 607 extend from spool 606 to fingertip caps (not shown) of the robotic glove system. Retraction motor 603 is connected to bevel gears 605 of gear assembly 613 via spindle 604.

In an implementation, when a controller of the robotic glove system commands the motor assembly to retract, retraction motor 603 causes bevel gears 605 to rotate which in turn causes spool 606 to rotate. As spool 606 rotates, it reels in lines 607 to pull and hold them taut. Retraction system 600 includes ratcheting sprockets 609a and 609b which hold bevel gears 605 and spool 606 in position against the pull of lines 607. To release lines 607, the controller of the robotic glove system transmits a signal to sprocket releases 611a and 611b causing them to retract and release ratcheting sprockets 609a and 609b. When released, bevel gears 605 and spool 606 move freely under the pull of lines 607, thus releasing the robotic glove system from the gripping configuration.

In an implementation, retraction motor 603 is a 75-rpm high-torque motor. In an implementation, sprocket releases 609a and 609b are electromagnetically driven. For example, sprocket releases 609a and 609b may be pin-type devices which engage sprockets of ratchet sprockets 609a and 609b, bearing the load of the pull of lines 607 transmitted to ratchet sprockets 609a and 609b. When the hold on lines 607 is to be released, an electromagnetic signal from the controller causes the pins to retract and disengage from ratchet sprockets 609a and 609b. In an implementation, sled 601 is made of a lightweight polymer (ABS) body. In an implementation, the bearings are ceramic.

FIG. 6B illustrates retraction system 600 in the context of a robotic glove system in an implementation. In FIG. 6B, sled 601 moves linearly on bearings 624a and 624b of track 621. Also illustrated in FIG. 6B, sled 601 is tethered to torsion spring 623 which exerts a light pull on the motor assembly toward the retracted position to reduce slack in lines 607 when the robotic glove system is in a neutral configuration. Line 625 tethering sled 601 to torsion spring 623 passes through solenoid 622 controlled by the controller of the robotic glove system. In operation, when the controller detects that the user is gripping his or her hand, the controller signals solenoid 622 to hold line 625 in position, thus holding sled 601 in position at the distal end of track 621. In an implementation, solenoid 622 is an elastic lockout solenoid which grips line 625 by friction-locking line 625 as it pulls against solenoid 622. To release sled 601 from the hold, the controller sends an electromagnetic signal to solenoid 622 to release line 625.

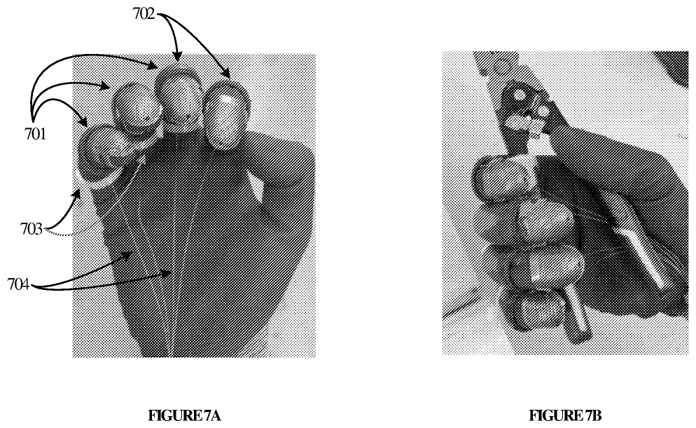

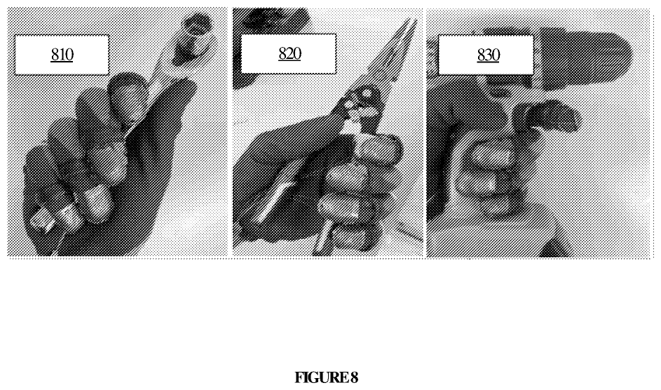

FIGS. 7A and 7B illustrate implementations of the fingertip caps of a robotic glove of which robotic glove system 101 of FIG. 1 is representative. Fingertip caps 701 are made from a hard material resistant to deformation, such as stamped brass with a copper frame. Attached to fingertip caps 701 are silicon elastomer ring supports 702 and line sheaths 703 which maintain lines 704 in position on the glove fingers. Fingertip caps 701 extend to the first (distal) finger joint.

FIG. 8 illustrates an implementation of a robotic glove, of which robotic glove 300 is representative, in use with various hand tools. Image 810 shows a robotic glove in use gripping a socket wrench with the user's four fingers curled around the handle of the socket wrench. Similarly, image 820 shows a robotic glove in use gripping pliers, and in image 830, the robotic glove is in use gripping a cordless drill. Image 830 further illustrates a glove configuration comprising a line secured to the fingertip cap at multiple attachment points.

The invention claimed is:

1. A robotic glove comprising:
one or more finger portions;
a motor assembly, wherein the motor assembly is connected by a line to each of the one or more finger portions, and wherein the motor assembly on a user's forearm maintains tension in the lines as the one or more finger portions move; and
a controller configured to:
detect a gripping motion by a user, and
provide a grip assist, wherein to provide the grip assist, the controller is configured to hold the motor assembly in a retracted position and to cause the motor assembly to take up slack in the lines.

2. The robotic glove of claim 1, wherein to hold the motor assembly in the retracted position, the controller is further configured to power a solenoid to hold the motor assembly at the retracted position, and wherein to cause the motor assembly to take up slack in the lines, the controller is further configured to power a motor to retract the lines to the one or more finger portions.

3. The robotic glove of claim 2, wherein the robotic glove further comprises a power supply, wherein the power supply supplies power to at least the solenoid and the motor.

4. The robotic glove of claim 3, wherein the power supply comprises a battery.

5. The robotic glove of claim 1, wherein each of the one or more finger portions comprises a fingertip cap positioned over an end of a respective finger portion.

6. The robotic glove of claim 1, wherein to detect the gripping motion, the controller is further configured to receive data from one or more electromyographic sensors on the user's forearm.

7. The robotic glove of claim 1, wherein the robotic glove is mounted on a ventral side of the user's forearm.

8. The robotic glove of claim 2, wherein the motor assembly comprises a spring, wherein the spring pulls the motor assembly to the retracted position.

9. A method of operating a robotic glove, the robotic glove comprising:
one or more finger portions;
a motor assembly, wherein the motor assembly is connected by a line to each of the one or more finger portions, and wherein the motor assembly moves on a user's forearm to maintain tension in the lines as the one or more finger portions move; and
a controller operatively connected to the motor assembly;
wherein the method comprises:
detecting, by the controller, a gripping motion by a user, and
providing a grip assist, by the controller, wherein to provide the grip assist, the controller is configured to hold the motor assembly in a retracted position and to cause the motor assembly to take up slack in the lines.

10. The method of claim 9, wherein the motor assembly further comprises a solenoid and motor, and wherein the method further comprises powering the solenoid to hold the motor assembly in the retracted position and powering the motor to retract the lines to the one or more finger portions.

11. The method of claim 10, wherein the robotic glove further comprises a power supply, wherein the power supply supplies power to at least the solenoid and the motor, and wherein the power supply comprises a battery.

12. The method of claim 9, wherein each of the one or more finger portions comprises a fingertip cap positioned over an end of a respective finger portion.

13. The method of claim 9, wherein detecting the gripping motion comprises receiving data from one or more electromyographic sensors on the user's forearm.

14. The method of claim 9, wherein the robotic glove is mounted to a ventral side of the user's forearm.

15. The method of claim 9, wherein the motor assembly comprises a spring, wherein the spring pulls the motor assembly to the retracted position.

16. A controller of a robotic glove, the robotic glove comprising:
one or more finger portions; and
a motor assembly, wherein the motor assembly is connected by a line to each of the one or more finger portions, and wherein the motor assembly moves on a user's forearm to maintain tension in the lines as the one or more finger portions move; and
the controller comprising:
one or more non-transitory computer-readable storage media; and
program instructions stored on the one or more non-transitory computer-readable storage media that, when executed by one or more processors, direct the robotic glove to at least:
detect a gripping motion by the user; and
provide a grip assist, wherein to provide the grip assist, the robotic glove is configured to hold the motor assembly in a retracted position and to cause the motor assembly to take up slack in the lines.

17. The controller of the robotic glove of claim 16, wherein to hold the motor assembly in the retracted position, the program instructions direct the controller to power a solenoid to hold the motor assembly in the retracted position, and wherein to cause the motor to retract the lines to the one or more finger portions, the program instructions direct the controller to power the motor to retract the lines to the one or more finger portions.

18. The controller of the robotic glove of claim 17, wherein the robotic glove further comprises a power supply, wherein the power supply supplies power to at least the solenoid and the motor, and wherein the power supply comprises a battery.

19. The controller of the robotic glove of claim 16, wherein to detect the gripping motion by the user, the program instructions direct the controller to receive data from one or more electromyographic sensors on the user's forearm.

20. The controller of the robotic glove of claim 16, wherein each of the one or more finger portions comprises a fingertip cap positioned over an end of a respective finger portion.
